(19) United States
(12) Patent Application Publication
(10) Pub. No.: US 2007/0010154 A1
(43) Pub. Date: Jan. 11, 2007

(54) REINFORCEMENT MATERIAL

(75) Inventor: Etienne Claeys, Waasmunster (BE)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: N.V. Syncoglas S.A., Zele (BE)

(21) Appl. No.: 11/456,840

(22) Filed: Jul. 11, 2006

Related U.S. Application Data
(63) Continuation of application No. 09/684,806, filed on Oct. 6, 2000, now abandoned.
Application No. 09/684,806 is a continuation of application No. 08/894,967, filed on Oct. 10, 1997, now abandoned.

(30) Foreign Application Priority Data
Mar. 2, 1995 (NL) 9500414

(51) Int. Cl. B32B 27/04; B32B 5/26; B32B 5/06; B32B 7/08

(52) U.S. Cl. 442/318; 442/319; 442/268; 442/270; 442/387; 442/414; 442/103

(57) ABSTRACT

The invention relates to a strengthening material, for instance for use as textile reinforcement in composites, comprising at least one thickness-providing layer formed by a non-woven or a knit of glass fibre and at least one strengthening layer connected thereto on at least one side thereof, wherein at least one of both strengthening layers is preferably embodied in glass fibre. Further described is a composite provided with a strengthening material according to the invention.

The present invention relates to a strengthening material for instance for use as textile reinforcement in composites.

Currently placed into composites consisting of plastic strengthened with a textile reinforcement are woven fabrics, mats, membranes, non-wovens etc.

In addition, a number of layers of textile reinforcement are also often employed simultaneously to obtain the required stiffness and resistance. The different layers are then mutually connected to thus obtain the desired thickness of the reinforcement. Mutual connection of these multi-layer structures can be carried out for instance by means of knitting machines (the so-called Rachel machines) which mutually connect the different layers by means of a fine yarn, using for instance the chain stitch. The drawback of employing for instance a polyester strengthening thread is that this does not withstand particularly well the effect of moisture and corrosive substances. In addition, the materials used are often not compatible with the resin, whereby they do not adhere thereto. This does not enhance the durability of the final product.

Composites provided with a textile reinforcement are applied for instance in flat objects such as panels, although more complicated pieces, such as boats, bumpers, junction boxes, bathtubs, telephone poles, tubes, profiles etc. are nowadays also often made of composite materials.

In the manufacture of flat composites such as for instance panels, most known strengthening woven fabrics and mats are sufficiently satisfactory. However, when complex shapes are made the textile reinforcements known up to the present time do not allow of sufficient moulding and folding or they behave in uncontrolled manner. Woven fabrics in particular are difficult to deform. Non-wovens quite often tend to behave uncontrolledly and/or tear.

The multi-layer structures also deform little or not at all when stretched if at least one of the layers is formed by a woven fabric. If one of the layers consists of a non-woven they deform in an uncontrolled manner.

It is the object of the invention to obviate the above mentioned drawbacks of particularly the multi-layer textile reinforcement. The invention has for its further object to provide a multi-layer textile reinforcement wherein composites of a great thickness (1 to 10 mm) can be made. Finally, the invention also has for its object to increase the durability of the composites provided with a textile reinforcement.

This is achieved by the invention with a strengthening material comprising at least one thickness-providing layer formed by a non-woven or a knit of glass fibre and at least one strengthening layer connected thereto on at least one side thereof. At least one of the strengthening layers is herein preferably embodied in glass fibre.

The use of a knit or a non-woven of glass fibre as central layer in such strengthening materials has not been described before.

With the strengthening material according to the invention stretching and draping of the reinforcement can take place in a regular and reproducible manner. Composites manufactured using the strengthening material according to the invention possess locations of different thicknesses which are predictable and reproducible.

In a particularly advantageous embodiment of the invention at least the middle layer is formed by a knit of glass fibre. Such a knit has an excellent deformability. The weight, thickness and deformability of the strengthening material can vary in accordance with the application.

In another preferred embodiment the middle layer is a non-woven embodied in glass fibre.

The strengthening material can be used in the manufacture of plastic composites by means of injection, vacuum technique, RIM, RTM etc.

With the strengthening materials according to the invention it becomes possible to realize a perfect resin transport over the full surface and through the full thickness of the workpiece. In addition, a regular and controlled deformation of the strengthening layers connected to the knit or the glass fibre non-woven becomes possible during moulding of the workpiece. The occurrence of tears and irregularities is hereby prevented, even at a local stretching of 100%. The middle layer, which is preferably formed by a knit or a non-woven in glass fibre, provides thickness to the strengthening material whereby the desired stiffness of the composites can be obtained.

It has been found that the delamination resistance of the composite is already significantly higher when at least the middle layer is embodied in glass fibre. Preferably however, the strengthening material is wholly embodied in glass fibre.

The strengthening layers can vary in weight, thickness and structure. They can be arranged on one or both sides of the middle layer. One or more of such layers can be used on each side. As strengthening layers can be used non-wovens, membranes, mats, woven fabrics, webs and the like. It will be apparent to the skilled person that, subject to the application, any desired per se known strengthening layer can be used as long as they are applied in combination with either a knit or a non-woven of glass fibre.

The connection of the layers is effected by means of per se known techniques, such as knitting, sewing, needle punching or adhesion. Combinations of different techniques can optionally be used. Needle punching or chemical binding (adhesion) is however recommended.

In the case of needle punching the different layers are fixed together in that the threads of the strengthening material are punched through by needles. Parts of the threads are herein pushed through the other layers, thereby resulting in a mechanical connection. Needle punched material has a number of advantageous properties. The strengthening material thus becomes more voluminous and woolly as a whole, whereby the surface is smoother and finer. This also has the result that composites can be made with a lower glass content. This is particularly advantageous with a view to cost. A three-dimensional strengthening results from a plurality of threads, or parts thereof, being pushed through the full thickness of the strengthening material. The delamination resistance of such a material is therefore very great. When only layers of glass are used and these are fastened to each other by needle punching, the strengthening material consists entirely of glass. Composites made herewith have a better resistance to the action of moisture and corrosive substances than composites wherein the different layers of the strengthening material are fastened together by means of for instance a polyester thread. Moreover, the strengthening material manufactured by needle punching is likewise suitable for use in composites wherein fire resistance is important (for instance phenol resins).

Chemical binding of the layers takes place by spraying or sprinkling the layers with a fine powder of a thermoplastic or thermosetting plastic. The whole is thereafter heated and pressed together, whereby the powder melts and the different layers adhere to each other. The advantage of such a manner of connection is that the thermoplastic powder dissolves in the resin used to form the composite and participates fully in the polymerization. The skilled person will appreciate that the choice of powder and resin must be such as to enable dissolving and participation in the polymerization. The advantage of chemical adhesion is again that the synthetic connecting thread in the composite is absent.

The strengthening material according to the invention makes it possible to perform the moulding of the end product, in flat or complex shapes, in a one-step process.

The invention further relates to composites provided with a strengthening material according to the invention.

The present invention will be further elucidated with reference to the accompanying example, which is only given by way of illustration and is not intended to limit the invention in any way whatsoever.

### EXAMPLES

### Example 1

A strengthening material according to the invention is manufactured on a conventional needle punching machine. The material consists of a middle layer formed by a knit embodied in glass fibre. The glass fibre is chosen such that it is suitable for processing with the used resin types. The knit has a weight of 200 g/m² and a thickness of 1.5 mm.

For strengthening purposes a non-woven is arranged on both sides of this middle layer. In this specific case a glass mat is used which is made in conventional manner and consists of chopped strands mutually adhered with adhesive powder. The fibres have a thickness of 10-50 tex and a length of 50 mm. The weight of the mat is 600 g/m². Such a mat is also referred to as CSM (=Chopped Strand Mat).

The three layers are mutually connected by means of the needle punching technique.

Starting from this textile reinforcement a composite is manufactured in complex shape by means of pressing, injecting and vacuum technique. The thickness of the composites formed in this manner is varied.

It has been found that in all the manufactured composites the stretching of the strengthening material in the complex shape of the matrix proceeds in the same manner as the manner in which the knit itself can be draped. The fibres of the glass mats connected to the knit by means of the needle punching technique follow the deformation of the knit whereby a regular, controlled and reproducible stretching of the glass mats is ensured. The result is that the end product does not have locations with resin concentrations alternating with locations of glass fibre concentrations. Either type of concentration would cause weak spots in the composite. Due to the great draping capacity of the middle layer, in this example the knit, it is possible to realize composites which locally require very large deformations of more than 100% of the strengthening material.

### Example 2

The same process as in example 1 is applied but instead of a knit a non-woven in endless glass fibre is used as middle layer between the two strengthening layers.

In this manner a strengthening material is obtained with which a 100% glass fibre-reinforced composite can be realized. This composite has a much higher delamination resistance than a composite with synthetic membrane as middle layer.

1. Strengthening material, for instance for use as textile reinforcement in composites, comprising at least one thickness-providing layer formed by a non-woven or a knit of glass fibre and at least one strengthening layer connected thereto on at least one side thereof.

2. Strengthening material as claimed in claim 1, characterized in that at least one of the strengthening layers is embodied in glass fibre.

3. Strengthening material as claimed in claim 2, characterized in that all layers are embodied in glass fibre.

4. Strengthening material as claimed in any of the claims 1-3, characterized in that the different layers are mutually connected by means of knitting techniques and/or adhesion and/or needle punching and/or sewing.

5. Strengthening material as claimed in any of the claims 1-4, characterized in that the strengthening layer is a non-woven, a woven fabric, a mat, a web or a membrane.

6. Strengthening material as claimed in any of the claims 1-5 wholly or partially impregnated with resin.

7. Composite provided with a strengthening material as claimed in any of the foregoing claims.
